(19) United States
(12) Patent Application Publication
(10) Pub. No.: US 2016/0185167 A1
(43) Pub. Date: Jun. 30, 2016

(54) SLIDE HAMMER BEAD BREAKER AND WHEEL TIPPER

(71) Applicants: Bosch Automotive Service Solutions Inc., Warren, MI (US); Robert Bosch GmbH, Stuttgart (DE)

(72) Inventors: Michael White, Montgomery City, MO (US); Robert J. Kochie, Dodge Center, MN (US); Robert A. Jensen, Clarks Grove, MN (US)

(21) Appl. No.: 14/930,983

(22) Filed: Nov. 3, 2015

Related U.S. Application Data
(60) Provisional application No. 62/074,282, filed on Nov. 3, 2014.
(60) Provisional application No. 62/091,829, filed on Dec. 15, 2014.

(51) Int. Cl. B60C 25/01; B60B 29/00

(52) U.S. Cl. CPC B60C 25/015; B60B 29/001

(57) ABSTRACT

A slide hammer bead breaker and wheel tipper tool includes a guide shaft, a weight slidably received within the guide shaft, and an impact head attached to an end of the guide shaft. The impact head includes a foot loop and a slot formed in each of two opposing sides, and includes a wedge protruding from an end opposite the guide shaft. The wedge is tapered and curved from the guide shaft to a tip, and includes a notch which separates the wedge into two wedge portions. Each foot loop is sized such that a user's foot can rest thereon.

### CLAIM OF PRIORITY

This application claims the benefit of priority to U.S. provisional patent application No. 62/074,282, filed on Nov. 3, 2014, and U.S. provisional patent application No. 62/091,892, filed on Dec. 15, 2014, the disclosures of which are incorporated herein by reference in their entireties.

### TECHNICAL FIELD

This disclosure relates generally to automotive tools, and, more particularly, to tools used to separate a tire from a rim and/or to flip a tire.

### BACKGROUND

Large vehicles, such as semi-trailer trucks and heavy load haulers usually have multiple sets of dual wheels to support the vehicle and load. Dual wheels are a pair of tire and wheel assemblies that are mounted immediately adjacent to one another on a single axle hub. These assemblies are able to bear greater loads than single wheels and also provide redundancy so that if one of the two tires fails, the second will continue to support the vehicle and load. This redundancy prevents loss of control of the vehicle and allows the vehicle to travel to a facility for repair. In dual wheel assemblies, the tires nearest to the body of the vehicle are referred to herein as the innermost wheels and the tires farthest from the body of the vehicle are referred to herein as the outermost wheels.

Each wheel 12 of each dual wheel assembly includes a rim 10 and a tire 14. As shown in FIG. 1, the rim 10 provides the structure and shape of the wheel 12, and the tire 14 covers the rim 10 to provide flexible, shock absorbing cushion to the wheel 12. The tires 14 used on modern vehicles are pneumatic tires made of a rubber material and including a tread 18 and a body 22. The tread 18 of the tire 14 provides traction for the tire 14 on the road surface, and the body 22 of the tire 14 provides containment for compressed air. Portions of the body 22 of the tire 14 which contact the rim 10 are known as beads 26, and portions of the body 22 of the tire 14 between the beads 26 and the tread 18 are known as sidewalls 30.

To ensure that beads 26 of the tire 14 fit tightly on the rims 10 of a wheel, beads 26 are typically made of high strength, low flexibility rubber and are typically reinforced with steel wire. This sturdy structure is intended to prevent the tire 14 from shifting or spinning on the rim 10 when the wheel rotates. If the beads 26 are not tight enough, friction between the traction of the tire 14 and the road will tend to prevent the tire 14 from rotating in unison with the rim 10.

When a wheel of this sort needs to be repaired or replaced, the entire wheel may be removed from the vehicle. These wheels are extremely heavy, with an individual wheel weighing as much as 200 to 250 lbs. or more. Accordingly, it can be difficult for technicians to perform various tasks, such as tipping wheels into an upright position, flipping a wheel during service, loading wheels for storage or transport, or even moving a wheel around a workspace. Injuries are common due at least in part to the wheel's high weight and the postures and movements customarily used to manipulate wheels.

Wheel tippers have been used in order to facilitate various tasks which require tipping or flipping a wheel. A wheel tipper is customarily a bar with a gripping end that engages with a wheel so that the wheel tipper can act as a lever when used by a technician. As an example, FIG. 2 illustrates a wheel tipper 40, sold by Bosch Automotive Service Solutions as product no. OTC 5082. The wheel tipper 40 comprises a body 42 that includes a grip end 44, and a hook end 46.

FIGS. 3-5 illustrate an example of a customary use of the wheel tipper 40 for tipping a wheel 12 into an upright position. To use this exemplary wheel tipper 40, before the wheel 12 is tipped, the tire 14 of the wheel 12 must be deflated and the bead 26 of the tire 14 broken, in order to expose the rim 10 of the wheel 12. FIG. 3 illustrates how the hook end 46 of the wheel tipper 40 is hooked to the rim 10 once the tire 14 is deflated and the bead 26 is broken. In FIG. 4, a technician 50, positioned on a side of the wheel 12 opposite from a side where the hook end 46 is hooked to the rim 10, pulls on the grip end 44 of the wheel tipper 40 until the wheel 12 is in an upright position as illustrated in FIG. 5.

In another task performed in a wheel servicing facility, once a wheel 12 is removed from the vehicle and has been positioned to be serviced, the bead 26 must be broken to separate the tire 14 from the rim 10. If the wheel servicing facility owns a tire machine, and if the tire to be serviced is the proper size to fit in the machine, then a tire machine may be used to break the bead of the tire. However, if that is not the case, the beads 26 are broken manually with hand tools. Various manual bead breaker tools exist for this purpose. However, these tools can be unwieldy, ineffective, and difficult to use. Additionally, a manual bead breaker tool is that it is one more tool that a wheel servicing facility must purchase for use, one more tool that a technician must locate for use, and one more tool that a technician must spend time transitioning between while servicing a tire.

Some manual bead breaker tools include slide hammers. A slide hammer includes a weight that is attached to a shaft and is slid up and down the shaft. The shaft usually includes at least one stop which stops the sliding motion of the weight, causing the weight to ram against the stop and thereby impart force through the shaft. The shaft of the slide hammer is placed against an object, the weight is slid up the shaft, gaining potential energy, the weight is then slid down the shaft until it contacts the stop, whereat the potential energy is converted into kinetic energy and is transmitted through the shaft and into the object.

One disadvantage of a slide hammer is that the amount of force generated is limited by the mass of the weight and how long the shaft is. The larger and heavier the tool, the more force it can impart, but the more cumbersome to store, transport, and operate. Conversely, slide hammers that are smaller and lighter, and therefore easier to store, transport, and operate, are not able to generate as much force. Slide hammers used as bead breakers suffer from this issue and must balance the high amount of force necessary to break the bead with the manageability of the tool in the wheel servicing facility.

It is desirable to have a single tool which can be used to both manipulate a wheel and to break the bead. Having a single tool which can be used for both functions reduces the number of tools that a wheel servicing facility must purchase, reduces the number of tools that a technician must locate for use, and reduces the amount of time that a technician spends transitioning between tools while servicing a tire. Additionally, having a single tool which can be used for both functions enables a technician to easily break the bead of the wheel from one side of the tire, flip the tire, and break the bead from the other side of the tire. Therefore, what is needed is a device that can be used for both manipulating a wheel and breaking the bead.

### SUMMARY

The following is a brief summary of subject matter that is described in greater detail herein. This summary is not intended to be limiting as to the scope of the claims.

In an embodiment, a single tool can be used to tip a wheel and to break the bead of the wheel. The tool includes a guide shaft, a weight slidably received within the guide shaft, and an impact head affixed to an end of the guide shaft. The guide shaft, weight, and impact head of the tool can be used as a slide hammer to impact the bead of a wheel. When the impact head is placed on the bead and the weight is slid within the guide shaft, the force imparted by the weight is transmitted through the impact head to break the bead.

To this end, the impact head is particularly configured to facilitate separating the rim and the tire of a wheel to break the bead. In particular, the impact head includes a foot loop formed on each of the opposing sides of the impact head as well as a wedge formed at an end of the impact head opposite the guide shaft. The wedge is tapered and curved from the guide shaft to a tip to easily fit between the rim and the tire of the wheel, and the foot loops are configured to enable a user to place his foot on the foot loops during use of the tool. The user's foot can then impart additional force onto the impact head and can also stabilize the tool and retain its position on the bead during impact from the weight.

The tool can also be used as a wheel tipper by attaching the tool to the wheel and using the tool as a lever with the wheel acting as a fulcrum. To this end, the impact head also includes a notch formed on each of the opposing sides of the impact head. The notches are sized to fit around the inside edge of the rim of the wheel. The impact head also has a partial length extending from the notches to the tip of the wedge. The partial length is greater than a diameter of a standard wheel hole of a rim of the wheel. To tip the wheel when the rim is facing upwardly, the user engages one of the notches around the inside edge of the rim and applies force to pivot the wheel about the notches into an upright position. To tip the wheel when the rim is facing downwardly, the user engages the partial length of the impact head within a wheel hole and levers the wheel about the impact head into an upright position.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 shows a cross-sectional view of a wheel.

FIG. 2 shows a perspective view of a prior art wheel tipper.

FIG. 3 shows a perspective illustration of a hook end of a prior art wheel tipper hooked onto a rim of a deflated tire with a broken bead.

FIG. 4 shows a perspective illustration of a user tipping the wheel of FIG. 2 with the prior art wheel tipper.

FIG. 5 shows a perspective illustration of the wheel of FIG. 2 tipped into an upright position.

FIG. 6 shows a perspective illustration of a slide hammer bead breaker and wheel tipper tool according to the present disclosure.

FIG. 7 shows a partial cross-sectional view of the tool of FIG. 6.

FIG. 8A shows a top view of the tool of FIG. 6.

FIG. 8B shows an end view of the tool of FIG. 6.

FIG. 8C shows an impact head of the tool of FIG. 6.

FIG. 8D shows a side view of the tool of FIG. 6.

FIG. 9 shows the tool of FIG. 6 being used to break a bead of a wheel.

FIG. 10 shows the tool of FIG. 6 being used to hook an inside of a rim of a wheel to be flipped.

FIG. 11 shows the tool of FIG. 6 being used to hook a wheel hole of a wheel to be flipped.

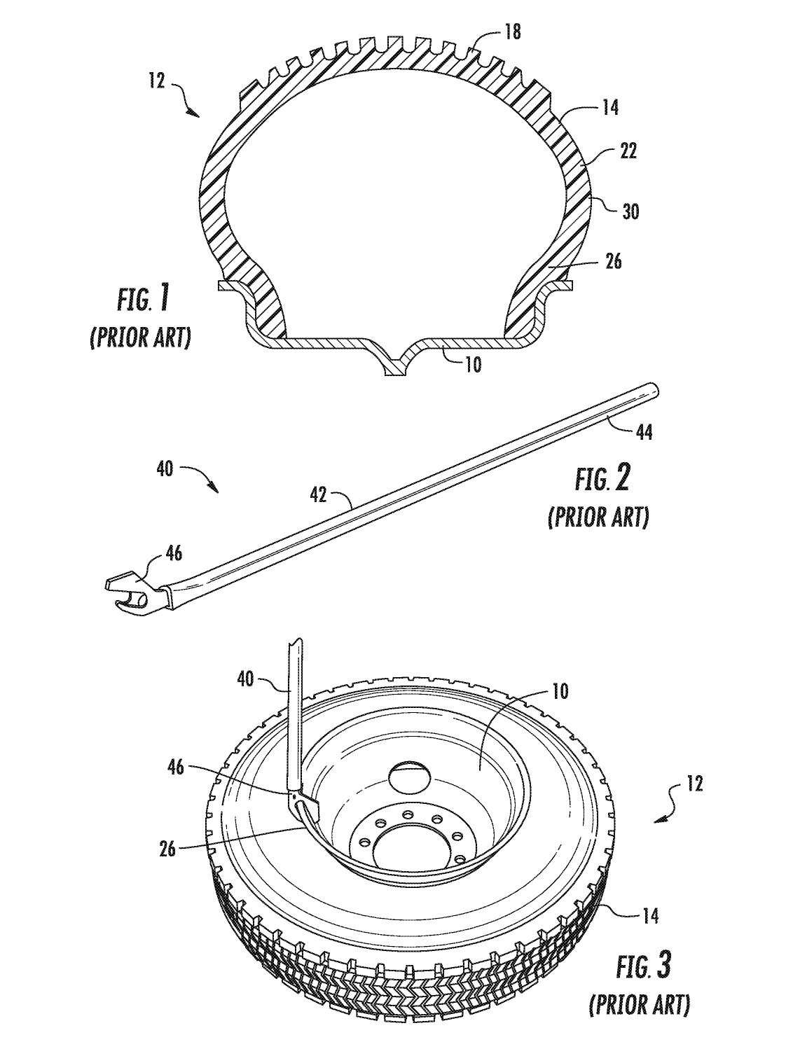

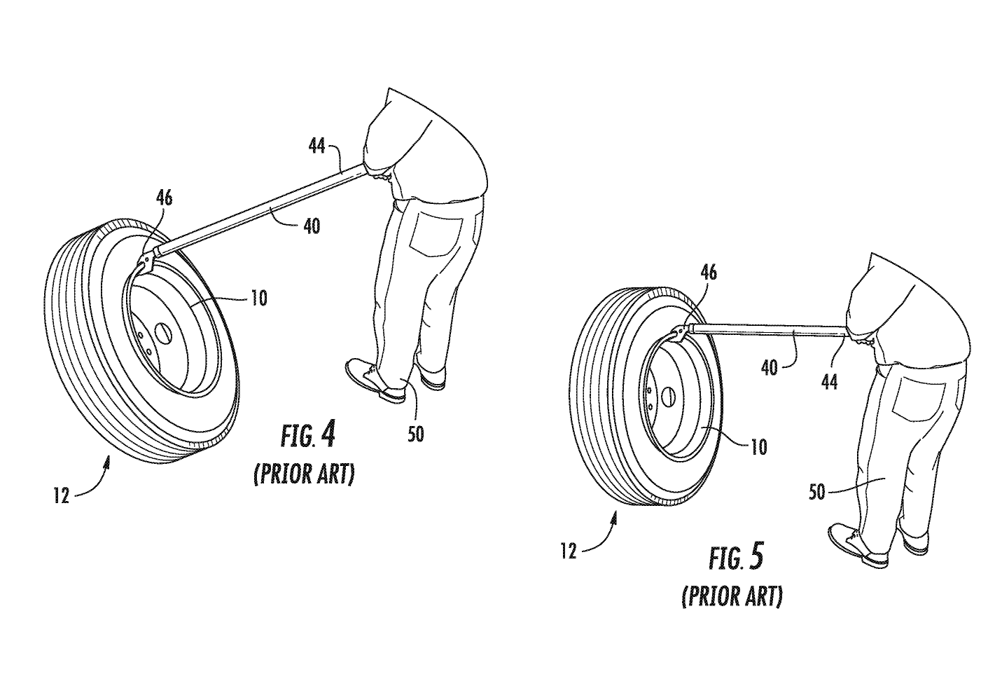

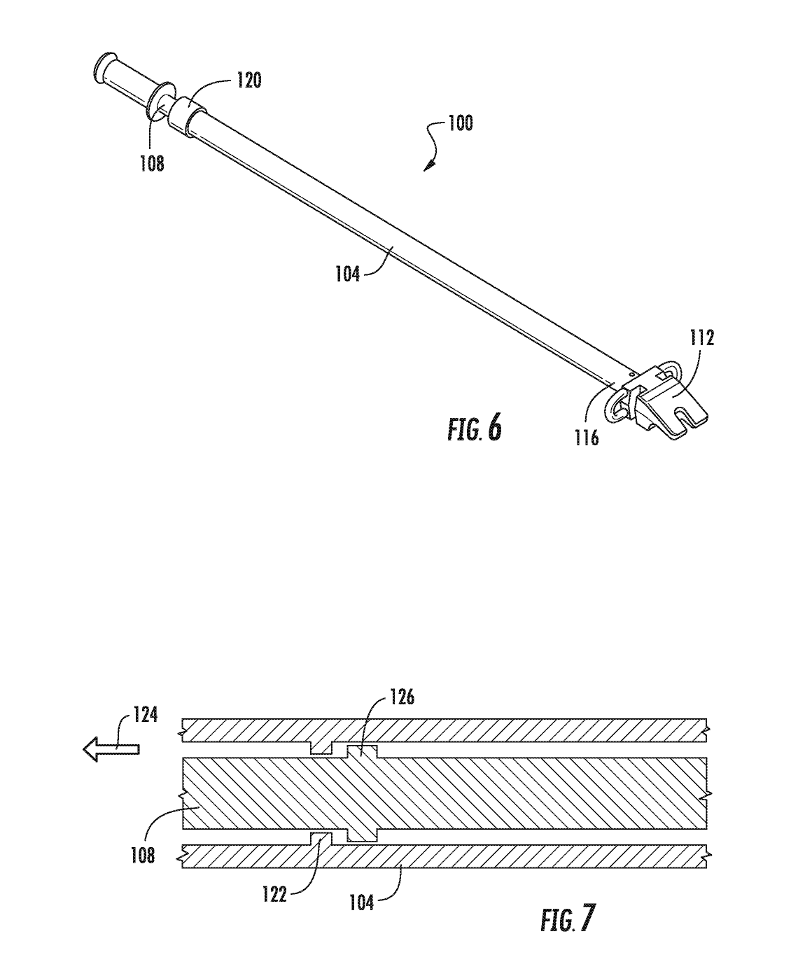

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

FIG. 6 is a perspective view of an embodiment of a slide hammer bead breaker and wheel tipper tool 100 according to the present disclosure. The tool 100 comprises a guide shaft 104, a weight 108, and an impact head 112. The impact head 112 is located at a head end 116 of the guide shaft 104 and can either be integrally formed with or fixedly attached to the guide shaft 104. The weight 108 slides within the guide shaft 104 and extends out of a handle end 120 of the guide shaft 104 located opposite the head end 116. As explained in more detail below, the guide shaft 104, weight 108, and impact head 112 together have a weight sufficient to provide substantial force to break the bead of the tire. For example, the guide shaft, weight 108, and impact head 112 together can weigh 21 pounds.

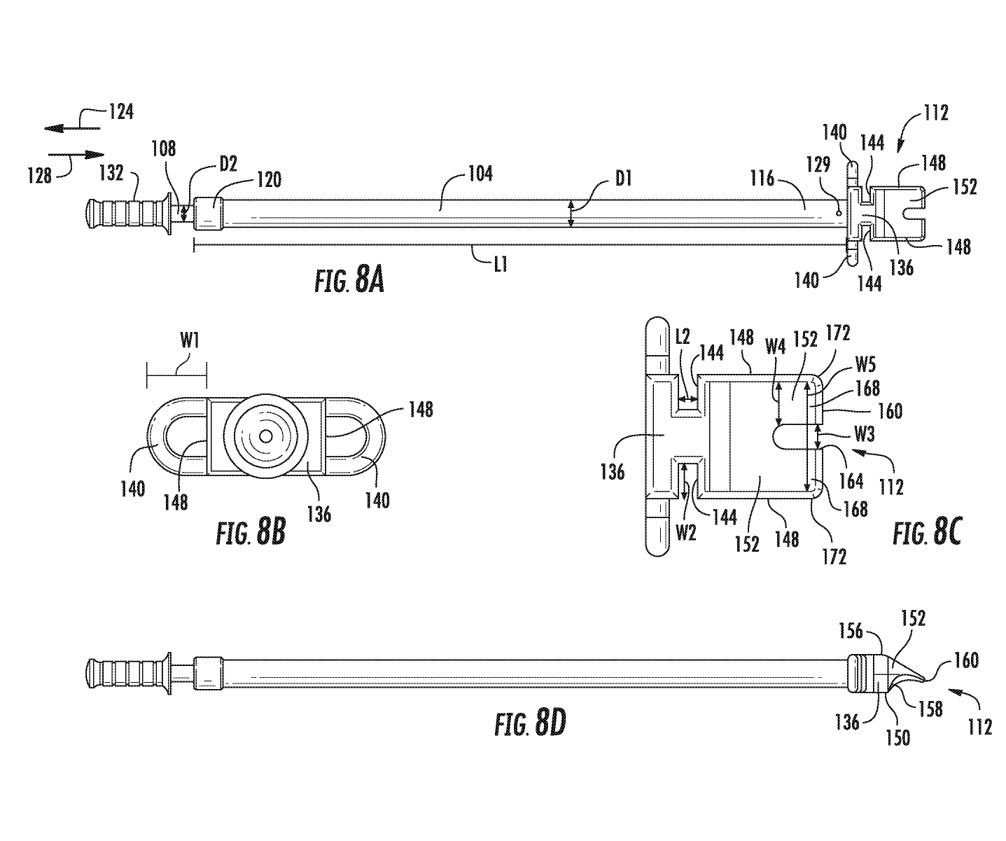

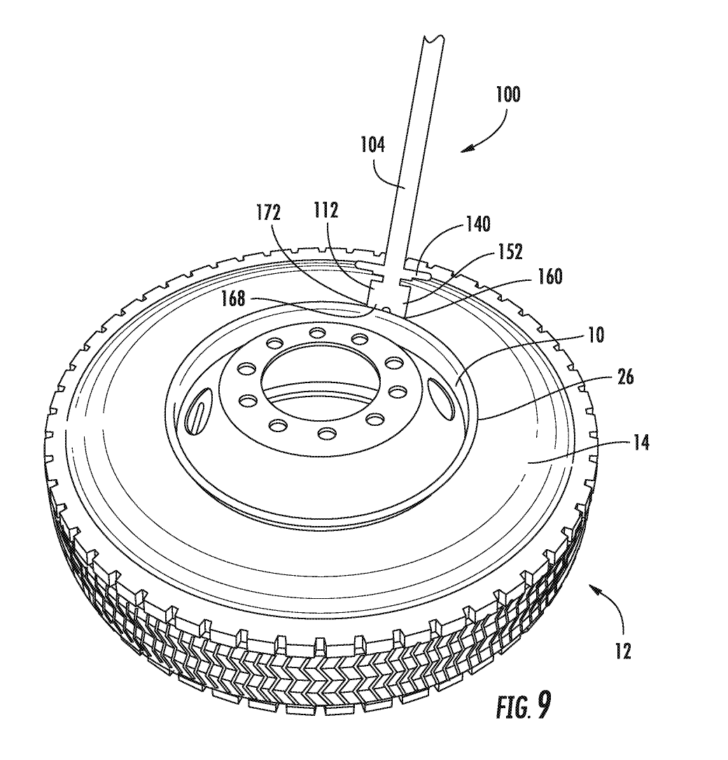

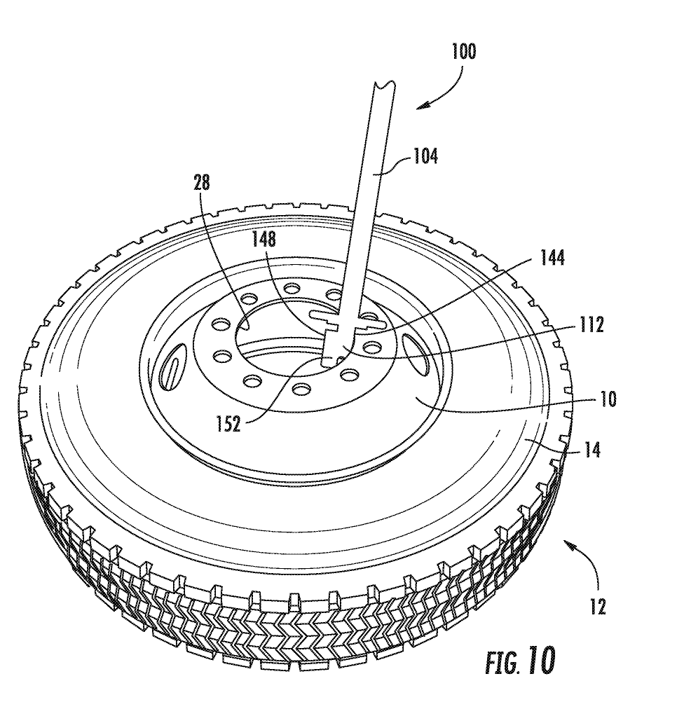

As shown in FIG. 8A, the guide shaft 104 is a hollow, cylindrical body having a diameter D1. The guide shaft 104 is made of a durable, rigid material such as, for example, steel. In alternative embodiments, the guide shaft 104 can be made out of a different material that is durable and rigid. The weight 108 is also a cylindrical body, but is solid and has a diameter D2. The weight 108 is made of a heavy, durable material such as, for example, steel. In alternative embodiments, the guide shaft 104 can be made out of a different material that is heavy and durable. The diameter D2 of the weight 108 is smaller than the diameter D1 of the guide shaft 104 to enable the weight 108 to slide closely and smoothly within the guide shaft 104. The weight 108 slides out of the guide shaft 104 in one direction of a longitudinal direction shown by arrow 124 and slides into the guide shaft 104 in the opposite direction of the longitudinal direction shown by arrow 128.

As shown in FIG. 7, in at least one embodiment, the hollow, cylindrical body of the guide shaft 104 includes a feature 122 configured to prevent the weight 108 from being removed entirely from the guide shaft 104 when slid in the direction 124. In the embodiment shown, the weight 108 includes a corresponding feature 126 configured to cooperate with the feature 122 to prevent the weight 108 from being removed entirely from the guide shaft 104. In particular, in the embodiment shown, the feature 122 is configured as an interior stop, such as a flange or a transverse pin, and the corresponding feature 126 is configured as an enlarged portion of the weight. The interior stop 122 is formed concentrically within the cylindrical body and has a diameter which is smaller than that of the enlarged portion 126 of the weight 108 such that the enlarged portion 126 of the weight 108 is not able to pass through the interior stop 122. In alternative embodiments, the feature 122 and the corresponding feature 126 can be configured differently so as to prevent the weight 108 from being removed entirely from the guide shaft 104.

Returning to FIG. 8A, the guide shaft 104 has a length L1 which is sufficient for the head end 116 of the guide shaft 104 to be positioned near a user's feet while the handle end 120 is held in a user's hand at a comfortable height around the user's torso. For example, the length L1 of the guide shaft 104 can be about 40 inches. The weight 108 has a length which is sufficient for the weight 108 to be slid a sufficient distance out of the guide shaft 104 in the direction 124 to generate substantial kinetic energy. Additionally, the length is sufficient such that a majority of the guide shaft 104 is filled with the weight 108, and the handle 132 still protrudes outwardly from the handle end 120. For example, the length of the weight 108 can be about 48 inches.

The handle 132 is configured to be gripped by the user. Accordingly, the handle 132 is sized and shaped to enable an easy and firm grip. The weight 108 is arranged within the guide shaft 104 such that the handle 132 always protrudes from the handle end 120 and is always spaced apart from the handle end 120 of the guide shaft 104. This arrangement protects the tool 100 from being damaged when the weight 108 is slid into the guide shaft 104 in the direction 128 and prevents the user from being pinched between the handle 132 and the handle end 120 when the weight 108 is fully received within the guide shaft 104.

The impact head 112 includes a body 136 which is affixed to or integrally formed with the guide shaft 104. Each of the opposing sides 148 of the body 136 includes a foot loop 140 and a slot 144, and a wedge 152 protrudes from an end of the body 136 opposite the guide shaft 104. As shown in FIG. 8B, the foot loops 140 protrude outwardly from the sides 148 of the body 136 at a width W1 sufficient to enable a user to rest a foot on a foot loop 140. For example, each foot loop 140 may protrude a width W1 of about 3 inches from the respective side 148 of the body 156.

Turning now to FIG. 8C, each slot 144 protrudes inwardly from the respective side 148 of the body 136 and has a width W2 and a length L2. The width W2 and the length L2 of each slot 144 is sufficient to enable the slot 144 to fit around an inside of a rim 10. For example, each slot 144 may have a width W2 of about 1 inch and a length L2 of about ½ inch.

Turning now to FIG. 8D, the wedge 152 can be seen from a side view. As shown, the wedge 152 tapers from an end 156 of the body 136 to a tip 160. Additionally, the wedge 152 curves toward a back side 150 of the impact head 112 as it tapers such that the wedge 152 is concave toward the back side 150. This curved, tapered shape of the wedge 152 enables the impact head 112 to be easily forced between the rim 10 and the tire 14 of a wheel 12 and to be levered against the tire 14 to break the bead of the wheel 12. Additionally, the curved shape of the impact head 112 includes a protuberance 158 configured to protrude into the concavity. The protuberance 158 is shaped to facilitate control of the tool 100 when flipping the wheel 12.

Returning now to FIG. 8C, the impact head 112 also includes a notch 164 formed in the center of the tip 160 of the wedge 152 so as to divide the wedge 152 into two identical wedge portions 168. The notch 164 has a width W3 of, for example, about ½ inch. Each wedge portion 168 is tapered toward the tip 160 and curved toward the back side 150 as described above, and each wedge portion 168 is curved along an outside edge 172. Each wedge portion 168 also has a width W4 of, for example, about 1.5 inches. In other words, in at least one embodiment the width W4 of each wedge portion 168 is approximately three times the width W3 of the notch 164. Accordingly, the tip 160 of the wedge 152 has a total width that is the sum of the width W4 of two wedge portions 168 and the width W3 of the notch 164. For example, the tip 160 of the wedge 152 has a total width of 3.5 inches.

The curved outside edges 172 of the wedge portions 168 further facilitate inserting the impact head 112 between the rim 10 and the tire 14 of the wheel 12. The widths W4 of the wedge portions 168 provide adequate surface contact area between the tip 160 of the wedge 152 to enable forcing the impact head 112 between the rim 10 and the tire 14, while the width W3 of the notch 164 reduces friction between the impact head 112 and the wheel 12 as the impact head 112 is forced between the rim 10 and the tire 14. Additionally, the notch 164 is configured to help drive a lubricant between the rim 10 and the tire 14 to further reduce friction and facilitate insertion of the impact head 112 between the rim 10 and the tire 14 to break the bead 26.

The tool 100 can be used to break the bead 26 of a wheel 12 by forcing the tip 160 of the wedge 152 between the tire 14 and the rim 10 of the wheel 12 as shown in FIG. 9. First, the impact head 112 is placed on the wheel 12 such that the curve of the wedge 152 is concave toward the rim 10 and convex toward the tire 14 and such that the tip 160 of the wedge 152 is positioned at the bead 26 of the wheel 12 with the outside edge 172 of each wedge portion 168 generally aligned along the bead 26. After the impact head 112 is so positioned, the user places a foot on one of the foot loops 140. The user's foot can help force the tip 160 of the wedge 152 between the tire 14 and the rim 10 and help stabilize and retain the tool 100 in place relative to the wheel 12.

Next, with the user's foot still on the foot loop 140 and the edges 172 in contact with the bead 26, the weight 108 (shown in FIG. 6) is lifted out of the guide shaft 104 in the direction 124 shown in FIG. 8A. As the weight 108 is lifted, it gains potential energy according to the mass of the weight and how far the user lifts the weight 108 in the direction 124. The user then releases and/or pushes the handle 132 (shown in FIG. 8A) of the weight 108 allowing it to fall and/or be moved in the direction 128 shown in FIG. 8A, sliding within the guide shaft 104. When the weight 108 is fully received within the guide shaft 104, the weight 108 is stopped by a surface, which causes a forceful impact. In the embodiment shown, the impact head 112 includes a pin 129 (shown in FIG. 8A) which couples the impact head 112 within the head end 116 of the guide shaft 104. In this embodiment, the pin 129 provides the surface which stops the weight 108 when the weight 108 is fully received within the guide shaft 104. In alternative embodiments, the stop can be formed as a closed bottom (not shown) in the guide shaft 104 between the weight 108 and the impact head 112, or the stop can be formed as a closed top (not shown) of the impact head 112 received within the head end 116 of the guide shaft 104.

The resulting impact when the weight 108 is fully received within the guide shaft 104 results in a force transmitted through the impact head 112, and thus through the wedge 152, to drive the tip 160 between the tire 14 and the rim 10. If the bead is not broken, the user can pull the tool 100 from the wheel 12, reposition the tool 100 in another location along the bead 26, and repeat the process described above.

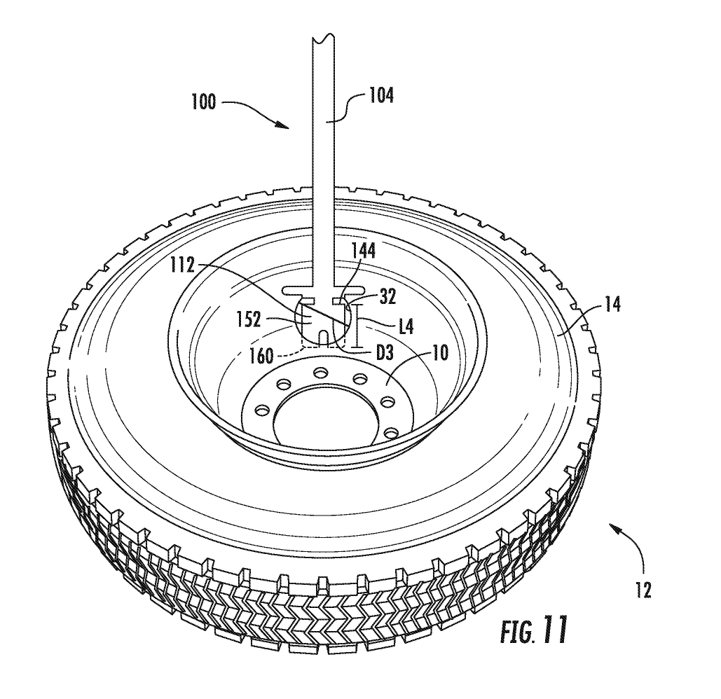

The tool 100 can also be used to flip the wheel 12. As shown in FIG. 10, the tool 100 can be used to hook an inside edge 28 of the rim 10 to flip the wheel 12 when the wheel 12 is arranged such that the rim 10 is facing upwardly. The user places the impact head 112 along the inside edge 28 of the rim 10 such that the inside edge 28 is fitted within one of the slots 144 formed on one of the sides 148 of the impact head 112 with the wedge 152 positioned within the rim 10. The user can then use the tool 100 as a lever and force the handle end 120 (shown in FIG. 6) of the guide shaft 104 downwardly to pivot the wheel 12 about the slot 144 into an upright position. Once the wheel 12 is upright, the user can roll or flip the wheel 12 as desired.

The tool 100 can also be used, as shown in FIG. 11, to flip the wheel 12 when the wheel 12 is arranged such that the rim 10 is facing downward. The impact head 112 has a partial length L4 which extends from the slots 144 to the tip 160 (shown in dashed lines behind the rim 10) of the wedge 152. The length L4 is longer than a diameter D3 of a standard sized wheel hole 32 of a standard rim 10. Accordingly, to flip the wheel 12, the user inserts the impact head 112 into the wheel hole 32 up to the slots 144 and then tilts the tool 100 to engage the tip 160 of the wedge 152 within the wheel hole 32. The user can then use the tool 100 as a lever and force the handle end 120 (shown in FIG. 6) of the guide shaft 104 downwardly to pivot the wheel 12 about the tip 160 into an upright position. Once the wheel 12 is upright, the user can roll or flip the wheel 12 as desired.

The protuberance 158 (shown in FIG. 8C) prevents the impact head 112 from being unintentionally inserted too far into the wheel hole 32, both during the insertion of the impact head 112 into the wheel hole 32 up to the slots 144 and during subsequent levering of the wheel 12 about the impact head 112. Thus, the protuberance 158 facilitates retaining control over the tool 100 while flipping the wheel 12.

Because the tool 100 enables easily flipping the wheel 12 from either side, the user can use the tool 100 to break the bead 26, as described above, from one side of the wheel 12, then use the tool 100 to flip the wheel 12 so that the opposite side of the wheel 12 is facing upwardly, and lastly use the tool 100 to break the bead 26 from the opposite side of the wheel 12. The user can perform all of these functions easily and without having to change tools.

It will be appreciated that variants of the above-described and other features and functions, or alternatives thereof, may be desirably combined into many other different systems, applications, or methods. Various presently unforeseen or unanticipated alternatives, modifications, variations or improvements may be subsequently made by those skilled in the art that are also intended to be encompassed by the disclosure.

What is claimed is:

1. A tool for manipulating and changing a tire, the tire having a bead and a rim, the tool comprising:
a hollow shaft having a first end and a second end;
a weight slidably received within the shaft and configured to slide through the first end of the shaft along a longitudinal direction, the weight including a first end, which is always disposed outside of the shaft, and a second end, which is always disposed inside the shaft; and
an impact head fixedly attached to the second end of the shaft, the impact head including:
a first portion configured to engage with the bead of the tire; and
a second portion configured to engage with the rim of the tire.

2. The tool of claim 1, wherein the first portion includes a wedge tapered in a direction away from the second end of the shaft to a tip, the tip configured to contact the bead of the tire.

3. The tool of claim 2, wherein the wedge is concave in a direction facing a first side of the impact head.

4. The tool of claim 1, wherein the second portion includes at least one slot formed in one of a first side and a second side of the impact head, the second side opposite the first side.

5. The tool of claim 4, wherein the at least one slot comprises a first slot and a second slot, the first slot formed in the first side of the impact head, and the second slot formed in the second side of the impact head.

6. The tool of claim 4, wherein the impact head further includes at least one foot loop arranged nearer to the second end of the shaft than is the at least one slot.

7. The tool of claim 6, wherein the at least one foot loop is formed on one of the first side and the second side of the impact head.

8. The tool of claim 6, wherein the at least one foot loop comprises a first foot loop and a second foot loop, the first foot loop formed on the first side of the impact head, and the second foot loop formed on the second side of the impact head.

9. The tool of claim 7, wherein:
the at least one slot extends into the impact head in a first direction; and
the at least one foot loop extends from the impact head in a second direction that is opposite the first direction.

10. The tool of claim 9, wherein:
the at least one slot comprises a first slot formed in the first side of the impact head in a first direction and a second slot formed in the second side of the impact head in a second direction, the first direction and the second direction opposite to one another; and
the at least one foot loop comprises a first foot loop extending from the first side of the impact head in the second direction and a second foot loop extending from the second side of the impact head in the first direction.

11. The tool of claim 1, wherein:
the first portion includes a wedge tapered in a direction away from the second end of the shaft to a tip, the tip of the wedge has a wedge width extending from a first side of the impact head to a second side of the impact head, the first side opposite the second side; and
the first portion further includes a notch formed in the tip of the wedge and having a notch width extending along a portion of the wedge width.

12. The tool of claim 11, wherein:
the wedge width is approximately seven times the notch width.

13. The tool of claim 11, wherein:
the second portion includes at least one slot formed in one of a third side and a fourth side of the impact head, the third side opposite the fourth side, the third side and the fourth side perpendicular to the first side and the second side;
and the at least one slot has a slot width extending in a direction parallel to the wedge width; and
the wedge width is approximately three and a half times the slot width.

14. The tool of claim 13, wherein:
the at least one slot has a slot length extending in a direction perpendicular to the slot width; and
the slot width is approximately two times the slot length.

15. The tool of claim 11, wherein:
the impact head further includes at least one foot loop extending from the impact head;
the at least one foot loop has a foot loop width extending in a direction parallel to the wedge width; and
the wedge width is approximately 1 to 1.2 times the foot loop width.

16. The tool of claim 15, wherein:
the wedge width is approximately 1.17 times the foot loop width.

17. The tool of claim 1, wherein the shaft includes a feature configured to prevent the weight from being removed entirely from the first end of the shaft.

18. The tool of claim 17, wherein the weight includes a corresponding feature configured to cooperate with the feature of the shaft to prevent the weight from being removed entirely from the first end of the shaft.
